(19) United States
(12) Patent Application Publication
(10) Pub. No.: US 2006/0213345 A1
(43) Pub. Date: Sep. 28, 2006

(54) Invalidating device for stacks of thin, planar objects

(76) Inventors: Karl Sauer Hartmut, Himmelstadt (DE); Holger Bernhardt, Veitshochheim (DE)

Correspondence Address: John MOETTELI;c/o BUGNION S.A., 10, Route de Florissant, P.O. Box 375, GENEVA 12, CH

(21) Appl. No.: 10/350,507

(22) Filed: Jan. 24, 2003

Related U.S. Application Data
(63) Continuation of application No. 09/526,783, filed on Mar. 16, 2000, now abandoned.

(30) Foreign Application Priority Data
Mar. 17, 1999 (CH) 0493/99

(51) Int. Cl. B26D 7/06

(52) U.S. Cl. 83/123; 83/124

(57) ABSTRACT

A device for invalidating planar security documents is provided. The device has a horizontal base plate (9) onto which objects (14) to be invalidated are placed, and die plates (13, 17, 18) which are vertically movable and parallel to the base plate. The device has a perforating apparatus supported on the base plate and the die plates, and a drive mechanism by which the die plates can be displaced up and down. The perforating apparatus has at least one cutting bushing (23) with a hollow paper punch (19) interacting with each cutting bushing in order to displace the paper scrap in the paper punch. The upper end of each paper punch (19) is open and provides an exit for the paper scrap into an upper storage cavity for containing the scrap. The cavity is in a support (03), having a vacuum connection, and is connectable to a vacuum apparatus for removal of the paper scrap.

### REFERENCE TO PRIOR APPLICATION

This is a continuation application of Ser. No. 09/526,783, of the same title, filed Mar. 16, 2000, the content of which is incorporated by reference hereto.

### BACKGROUND OF THE INVENTION

The invention concerns a device for invalidating planar objects by perforation means, in particular, invalidating stacks of defective thin, planar products in the securities sector, such as banknotes, notes of value etc. having a horizontal base plate onto which the objects to be invalidated are placed, and having die plates which are vertically movable and parallel to said base plate, and having a drive mechanism by which the die plates can be displaced up and down. Furthermore, the invention concerns a method of invalidating such objects.

Invalidating machines are known. European Patent Application EP 0 603 127, the content of which is incorporated by reference, discloses, for example, such a machine which has in particular a punching mechanism in which the cutting plate, onto which the objects to be perforated are placed, has holes in a desired arrangement and in which a die plate is provided with corresponding perforating pins. During downward movement of the die plate, the objects are perforated by the pins, which are aligned with the holes and engage in them.

In other known invalidating machines, the paper is drilled by means of a drilling machine. The advantage of this machine is that the total thickness of the product to be invalidated can be greater than in the case of an invalidating machine using punches.

In any event, the scrap from punching drops down onto the production line, which is unfavorable.

### SUMMARY OF THE INVENTION

The invention has as an object the improvement of known invalidating machines.

The invention's primary object is to provide an invalidating device in which the scrap from invalidating is collected.

The invention has the further object of achieving an inline invalidation of planar objects, in particular products in the securities sector, such as banknotes, notes of value or coupons, in which the invalidation of defective security products is guaranteed with a machine of an acceptable overall size, and in which a greater total thickness of the products than was previously possible can be processed.

The invention has several advantages, including guaranteeing the invalidation of paper products with a total thickness of about 8 to 15 mm by an invalidating unit of an acceptable overall size, and the 100% removal of the punching remains into a suitable storage space.

### BRIEF DESCRIPTION OF THE DRAWINGS

The invention is explained in more detail on the basis of an exemplary embodiment with reference to the drawings, in which:

FIG. 1 shows a schematic front view of an invalidating device according to the invention,

FIG. 2 shows a schematic side view of the invalidating device,

FIG. 3 shows a detailed front view of the invalidating device, and

FIG. 4 shows a block-diagram of an invalidating process according to the invention.

### DETAILED DESCRIPTION OF THE PREFERRED EMBODIMENT(S)

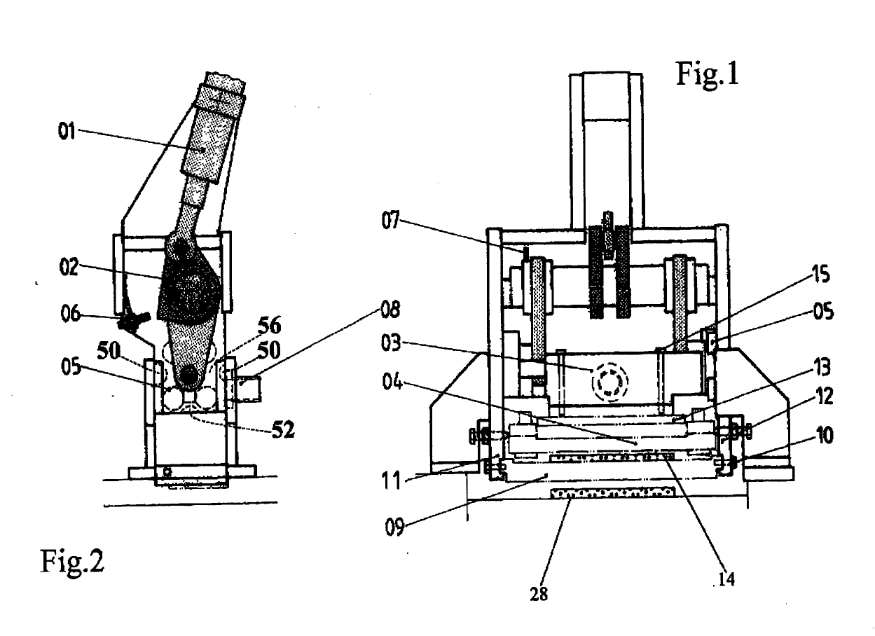

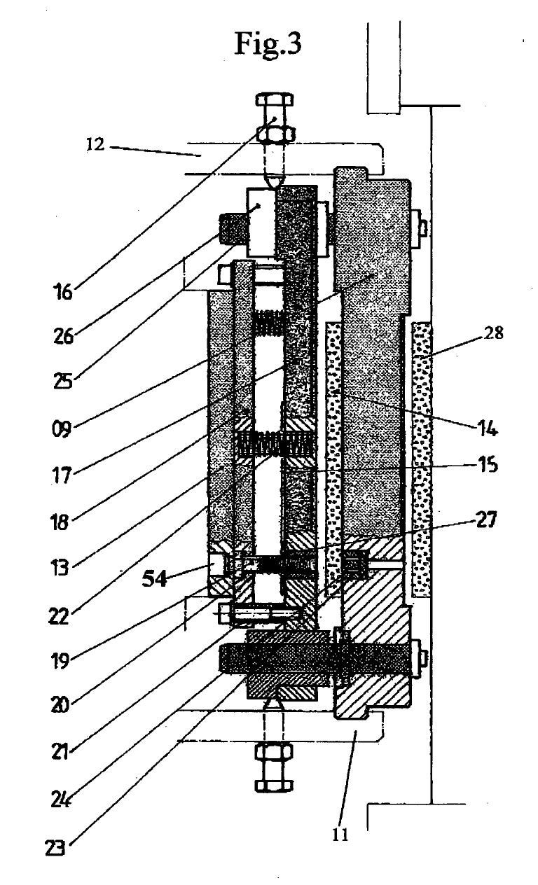

As represented in FIGS. 1 and 2, the invalidating device has a base plate or cutting plate 09, onto which the material to be punched 14, i.e. the objects to be perforated, is placed. Parallel to this base plate 09 is a die plate 04 which comprises a pressing plate 13 screwed to a support 03 by screws 15, a guide plate 17 and a punch-receiving plate 18 (FIG. 3) into which punches for perforating the material to be punched 14 are received. The support 03 has sidewalls 50 and a bottom 52 defining a cavity 56. The cavity 56 of the support 03 can thus serve as a receptacle or container for the scrap punched upwardly through a port 54. An industrial vacuum cleaner may be connected at a connection 08 for the automatic suction removal of the paper scrap.

The base plate 09 is screwed to fixed side walls 11 and 12 of the device preferably by screws 10.

An eccentric shaft 02 is turned by a hydraulic cylinder 01 in such a way as to produce a travel of the support 03 and of the die 04 of several millimeters, approximately 20 mm. Of course, other means may be used to displace the support vertically. The support 03 is guided on both sides by running rollers 05, it being possible for pairs of running rollers to be eccentrically mounted in order to make the guidance free from backlash. Such means thus allow a very good guiding of the plates vertically and maintain the force actuating the invalidating device perpendicular to the surface of material to be punched 14 (see FIG. 3). The travel executed can be controlled by contact 06 mounted in the machine and cooperating with pin 07, which is fitted on the eccentric shaft 02. Hence, the rotation of the eccentric shaft 02 can be stopped when the punches 19 have punched the material 14 (see FIG. 3).

The invalidating device is described in more detail with reference to FIG. 3. It mainly comprises the following elements: base plate or cutting plate 09, guide plate 17, punch-receiving plate 18 and pressing plate 13. The pressing and punch-receiving plates 13, 18 are connected to the guide plate 17 by spacer rings 21 and springs 22. These plates are guided parallel to the base plate by means of guide bars 25, which are fixedly connected to the base plate 09.

The paper punches 19 are mounted on the punch-receiving plate 18 and are inserted with shims 20 between receiving plate 18 and pressing plate 13 such that they are free from backlash. The paper punches 19 are made of hard metal, such as hard steel, with a hollow configuration and are guided in the vertical direction by means of guide bushings 27 in the guide plate 17. Provided in the base plate or cutting plate 09 are interacting cutting bushings 23, which serve as a counterpiece for the paper punches 19 during the invalidating operation. Said bushes 23 are also made of hard metal, such as steel.

During the invalidating operation, the guide plate 17, actuated by the pressing plate 13 through the eccentric shaft 02, slides along guide bars 25 onto the material to be punched 14, for example a bundle of banknotes, and acts via the springs 22 as a pressing plate, before the paper punches 19 enter the material to be punched 14. The pressing plate 13 continues then its downwards motion, guided along the spacer rings 21, and the paper punch 19 are forced in the material to be punched 14, since the eccentric shaft 02 continues its rotational motion in the same direction. The paper punch 19 are guided in the guide plate 17. Because the base plate 09 has a cutting bushing 23, corresponding to each paper punch 19, all the paper scrap generated during perforating of the material 14 by the hollow paper punch 19 is pushed forward inside the hollow paper punchs 19. In addition, the paper punches 19 are open at the upper end, so that the paper scrap is ultimately pushed out into the support 03 and collected at the top. A suction removal of the scrap can take place via the connection 08 (FIGS. 1 and 2).

Ejectors 24 are provided in the cutting bushings 23 for pushing out the scrap from punching. The entry depth of the paper punches is chosen such that the ejectors 24 push the scrap from punching up in the paper punch 19. For reliable functioning, it must preferably be ensured that the upper edge of the ejectors 24 is several millimeters lower than the upper edge of the cutting bushing 23.

The force of the springs 22 during the return travel is generally not enough to pull the paper punches 19 out of the material being punched, once the invalidating operation has been carried out and the material that has been punched is also lifted together with the plates 13, 17 and 18 by eccentric shaft 02. For this purpose, four adjustable stops 16 which limit the path of the guide plate 17 in the upward direction are provided on the side walls 11 and 12 of the punching machine. When the guide plate 17, the punch-receiving plate 18 and the pressing plate 13 are lifted off by means of the hydraulic cylinder 01 and the eccentric shaft 02, at first the guide plate 17 is stopped in its upwards movement by the stops 16. The further movement of the eccentric shaft 02 then lifts off only the punch-receiving plate 18 and the pressing plate 13, along the shims 20 with the paper punches, until the paper punches 19 have been pulled completely out of the material that has been punched 14 and they return in their starting position (FIGS. 1 and 3).

The stops 16 are of course set when the die is not loaded and may be adjusted to comply with the size of the invalidating device which is mounted between side walls 11, 12.

The number of paper punches depends on the dimensions of the objects to be perforated. With a product of 100 ? 200 mm in size, up to 12 holes (? 10 mm) can be punched. With such a machine, it is thus possible for all 12 holes to be punched simultaneously. In the case of products in the securities sector, the total thickness may be 8 to 15 mm.

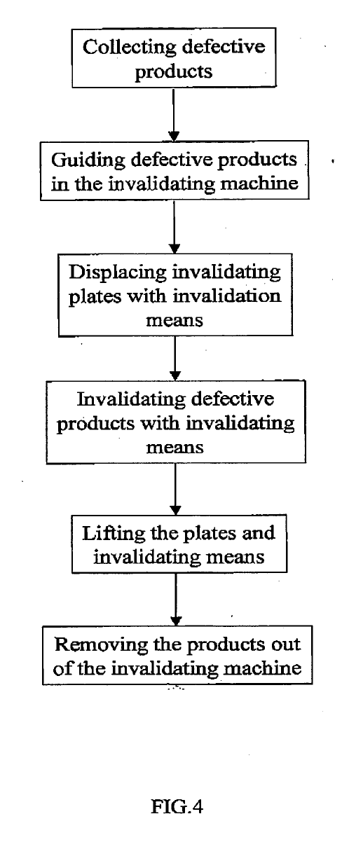

The method of invalidating planar objects, in particular defective products in the securities sector, such as bank notes, notes of value etc., by perforation is schematically represented at FIG. 4 and comprises the following steps once the defective products have been sorted out:

guiding the defective products onto a base plate in the invalidating device;

displacing die plates onto the products to be invalidated by means of a drive mechanism;

invalidating the products by hollow paper punches, with the paper scrap being collected inside the paper punches;

lifting the die plates off and pulling the paper punches out of the invalidated products, and

pushing the products out of the invalidating machine.

The invalidating machine is best used in a production line for security products in which an inline process of detecting or distinguishing between products to be invalidated and not to be invalidated is carried out.

In such a production line, bundles of defective products, for example defective banknotes, and bundles of satisfactory products are formed in a separate manner, so that in the course of production various bundles or piles come past the punching machine. In this case, detecting means are provided to distinguish between the different piles, in order that, as schematically represented in FIG. 3, the piles with defective products (material to be punched 14) pass into the invalidating machine, while the piles with satisfactory products 28 are guided under the base plate 09. The piles of defective products are preferably marked with a specific mark, for example an “X” or specific words such as “VOID”, that can be easily detected, for example by a camera.

After the detecting means, such as mentioned a camera or other optical means for detecting the bundles to be punched, a ramp is placed in the production line, on which the bundles or piles to be invalidated are pushed into the invalidating machine, on the base plate 09. If the bundle following a bundle to be invalidated is not to be invalidated, the ramp remains in an upper position, in order that the bundle can be pushed under the base plate and consequently not be invalidated.

The invalidating machine may accordingly be built as a modular system and integrated in an existing production machine or line. Indeed, it is only necessary to provide a ramp to bring the piles of material to be invalidated on the base plate of the machine, and the invalidating operation is carried out with no influence on the production process, since the piles of good products are not brought in the invalidating machine and the waste is removed at the top of the machine. Further, it is possible to provide a specific transporting section (not represented) at the same level than that of the base plate 09, on which the invalidated piles 14 are transferred, once invalidated, so that they do not return in the succession of piles 28 with satisfactory products, which passes underneath the invalidating machine, but are brought to a specific place only for invalidated piles of material. The further treatment of the satisfactory products is thus easier to carry out.

The invalidating machine according to the invention is not limited to the embodiment described by way of reference and modifications may be undertaken.

Although illustrative embodiments of the invention have been shown and described, a wide range of modification, change and substitution is contemplated in the foregoing disclosure and in some instances, some features of the present invention may be employed without a corresponding use of the other features. Accordingly, it is appropriate that the appended claims be construed broadly and in a manner consistent with the scope of the invention.

What is claimed is:

1. A device for invalidating planar security documents, the device having a horizontal base plate (9) onto which objects (14) to be invalidated are placed, and die plates (13, 17, 18) which are vertically movable and parallel to said base plate, and having perforating means supported on the base plate and the die plates, a drive mechanism by which the die plates can be displaced up and down, wherein the perforating means comprises at least one cutting bushing (23) with a hollow paper punch (19) interacting with each cutting bushing in order to displace the paper scrap in the paper punch, wherein the upper end of each paper punch (19) is open and wherein an exit for the paper scrap is directed upwardly, directly into an upper storage cavity for containing the scrap, the cavity being in a support (03), having a vacuum connection, and being connectable to a vacuum apparatus for removal of the paper scrap.

2. The device as claimed in claim 1, wherein the cutting bushing (23) is provided in the base plate (9), and wherein the paper punch (19) is provided on the die plates (13, 17, 18).

3. The device as claimed in claim 2, wherein the die plates include a guide plate (17) having guide surfaces which receive and guide the paper punch (19) and which support paper products during punching, thus serving as a pressing plate for the paper products (14) to be invalidated, a punch-receiving plate (18), which receives the paper punches (19), and a pressing plate (13).

4. The device as claimed in claim 1, wherein the die plates include a guide plate (17) having guide surfaces which receive and guide the paper punch (19) and which support paper products during punching, thus serving as a pressing plate for the paper products (14) to be invalidated, a punch-receiving plate (18), which receives the paper punches (19), and a pressing plate (13).

5. The device as claimed in claim 1, wherein the die plate includes a pressing plate (13) and a receiving plate (18) which are connected at least to springs (22).

6. The device as claimed in claim 2, wherein the die plate includes a pressing plate (13) and a receiving plate (18) which are connected at least to springs (22).

7. The device as claimed in claim 1, wherein the die plates include a guide plate, and wherein stops (16) which limit the upper path of the guide plate (17) in order to pull paper punches (19) out of the material being punched (14) are provided on the sides of the device.

8. The device as claimed in claim 2, wherein the die plates include a guide plate, and wherein stops (16) which limit the upper path of the guide plate (17) in order to pull paper punches (19) out of the material being punched (14) are provided on the sides of the device.
